(19) United States
(12) Patent Application Publication
(10) Pub. No.: US 2009/0106992 A1
(43) Pub. Date: Apr. 30, 2009

(54) KWIK LEADS

(75) Inventor: Stephen E. Howell, Iron Station, NC (US)

Correspondence Address: SUTHERLAND ASBILL & BRENNAN LLP, 999 PEACHTREE STREET, N.E., ATLANTA, GA, 30309, US

(73) Assignee: QUICK LEADS LLC, Raleigh, NC (US)

(21) Appl. No.: 12/330,426

(22) Filed: Dec. 8, 2008

Related U.S. Application Data
(63) Continuation of application No. 11/526,333, filed on Sep. 25, 2006, now Pat. No. 7,461,461.
Application No. 11/526,333 is a continuation of application No. 11/088,624, filed on Mar. 24, 2005, now abandoned.
(60) Provisional application No. 60/556,791, filed on Mar. 29, 2004.

(51) Int. Cl. G01B 1/00

(52) U.S. Cl. 33/407; 33/518

(57) ABSTRACT

An improved tool and method for vertically aligning bricks in a wall is provided. The tool may include an elongated member for placing against an outer face of a brick wall and a cross member for placing against a top course of brick in the brick wall. The cross member may be attached to the elongated member at a right angle thereto. Additionally, a position of a distal end of the cross member relative to the elongated member may be adjustable.

### CROSS REFERENCE TO RELATED APPLICATIONS

This application is a continuation of co-pending U.S. patent application Ser. No. 11/526,333, filed Sep. 25, 2006, and entitled “Kwik Leads,” which is a continuation of U.S. patent application Ser. No. 11/088,624 (now abandoned), filed Mar. 24, 2005, and entitled “Kwik Lead.” This application also claims the benefit of U.S. Provisional Patent Application No. 60/556,791, filed Mar. 29, 2004, and entitled “Kwik leads.” The disclosures of each of these applications are incorporated by reference herein in their entirety.

### FIELD OF THE INVENTION

Embodiments of the invention relate to brick laying, and more particularly to a method and apparatus for properly aligning bricks by a brick mason.

### BACKGROUND OF THE INVENTION

The art of brick laying is hundreds of years old. Typically, brick layers rely on line of sight for establishing the verticality of walls. Consequently, bricklaying is expensive. Aspects of bricklaying which require particular skill and time include laying level courses of brick during formation of a wall, and maintaining a true vertical wall face. These constructions are performed by hand, laborious, and particular attention is required to make the wall as close as possible to a true vertical.

An important problem confronted in conventional brick laying is that there are no adequate tools for accurately placing bricks to establish a perfectly plumb wall in restricted spaces, such as under eaves.

Accordingly, what is needed is a device to aid the bricklayer in establishing a plumb wall a specific distance from the wall for which the brick wall will become the outer face.

The work performed without this tool takes approximately two to three times longer with inferior quality results. Another problem with conventional brick laying is the additional manpower required. Also, using the line of sight method with conventional brick laying can produce results of unacceptable quality.

In this respect, the Kwik Leads tool according to various embodiments of the invention substantially departs from the conventional concepts and designs of the prior art, and in so doing provides an apparatus primarily developed for the purpose of ease of brick laying and improved quality in the manufacture of homes and commercial buildings.

Although the invention is described with relation to the laying of bricks, the term “bricks” as used throughout this application is to be understood to be any type of masonry, including, without limitation, brick, cement block, stone, and tile.

### SUMMARY OF THE INVENTION

The invention is a generally T-shaped tool, the top member of which is adjustable with relation to the base member, and which can be fixed into a desired orientation with relation to the base member. In operation, the distance from the wall of the structure to the desired location of the brick face is determined, and that distance is set on the tool by affixing the shorter cross member to the base or elongated member by set screws or bolts. The tool is then utilized to confirm the distance from the base wall to the brick face frequently during the laying of the bricks.

A structure is built with a wall having an outer skin thereon, frequently insulation, after which a brick wall is laid on the face of the outer skin, or frequently spaced from the outer skin of the wall. During normal operation, the brick mason lays a course of brick in the normal manner, and continues in the same manner utilizing a level in the vertical position for several courses, until the height of the brick wall exceeds the length of the invented Kwik Leads tool or guide. The tool is set prior to commencing the facing of the wall with brick. The desired distance from the outer skin and the face of the brick is determined, and the top member is fixed so that it extends beyond the face of the elongated base member the desired distance which is equal to that from the face of the brick wall to the outer skin of the structure. The bricklayer then places the bottom of the top member of the tool on the top course of brick with the end of the top member of the tool against the outer skin and the inner face of the elongated base member against the face of the brick to determine the verticality of the wall, and to provide an exact location for the face of the brick.

Embodiments of the inventions may be particularly useful for laying a vertical wall, especially in the region where there is an overhang, such as under eaves.

The invented apparatus has an elongated member having a smooth face for contacting a wall of bricks. An end member is attached to the end of the elongated member at a right angle thereto. The end member is advantageously attached in an adjustable manner. The elongated member may be provided with a handle for ease of manipulation.

### BRIEF DESCRIPTION OF THE DRAWINGS

The foregoing and other objects will become more readily apparent by referring to the following detailed description and the appended drawings in which:

FIG. 1 is an isometric view of the invented tool in use on a brick wall.

FIG. 2 is a top view of the invented tool.

FIG. 3 is a front view of the invented tool.

FIG. 4 is a right side view of the invented tool, the left side view being a mirror image thereof.

FIG. 5 is a rear view of the invented tool.

FIG. 6 is a top view of an alternative embodiment of the invented tool.

FIG. 7 is a right side view of the alternative embodiment of FIG. 6, the left side view being a mirror image thereof.

### DETAILED DESCRIPTION

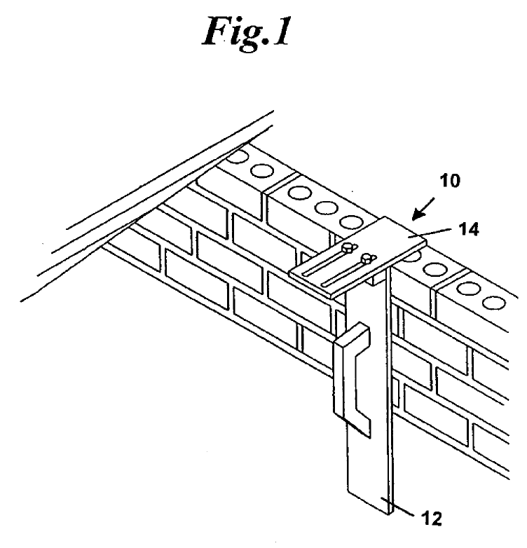

Referring now to the drawings, and particularly to FIG. 1, the invented Kwik Leads device 10 includes an elongated base member 12, an end member 14 which forms a “T” with the base member 12, and adjustable connecting means between the members 12 and 14. Between the base member 12 and the end member is a connector flange 16 which can be integral with the base member as shown by reference numeral 36 in FIG. 7, welded or otherwise fixed to the base member, or it can be an intermediate block, as shown in FIG. 4, which is fixed to the base member with screws, not shown, and thus becomes part of the base member. The adjustable connection can include two parallel slots 18 at right angles to the base member, with bolts 20 which connect to the connector flange or block. The bolt receiving hole or holes in the connector flange or block are preferably drilled and tapped. Alternatively, regular bolts with nuts can be employed.

A handle 22 may be provided for ease in holding and manipulating the tool in different directions, and in placing and removing the Kwik Leads tool in the brick laying process. The handle 22 may be generally “U” shaped, as shown, or may have any other desired shape.

The base member is advantageously provided with a scale with measurements stamped or etched thereon at various desired locations, as shown in FIG. 3, and used as the brick mason's course guide.

In the process of brick laying, all bricks must be put into place to form a described architecture. The bricks must be straight and uniform. Conventional methods of brick laying allows a certain amount of deviation, which can result in a wall structure being several inches out of plumb, which would cause it to be rejected by the contractor. The invented tool is used to ensure that each row of brick is exactly the same distance from the face of the brick to the face of the wall. The mason lays two or three bricks then uses the Kwik Leads tool to ensure plumb. By holding the end of the adjustable end member against the existing wall, the bricks are checked for plumb or verticality, and are also checked for uniformity against the scale on the elongated member.

The invented toot is preferably made from aluminum, can be made from any suitable materials, including aluminum, steel, wood, and plastics, or a combination thereof.

Advantageously, the base member and end members are made of ¼ inch aluminum plate, and the connector block is also aluminum, which may be drilled and tapped to receive the required connecting screws and adjusting bolts. A conveniently sized tool has a 3½″.times.7¼″ end member and a 3½″.times.16″ base member.

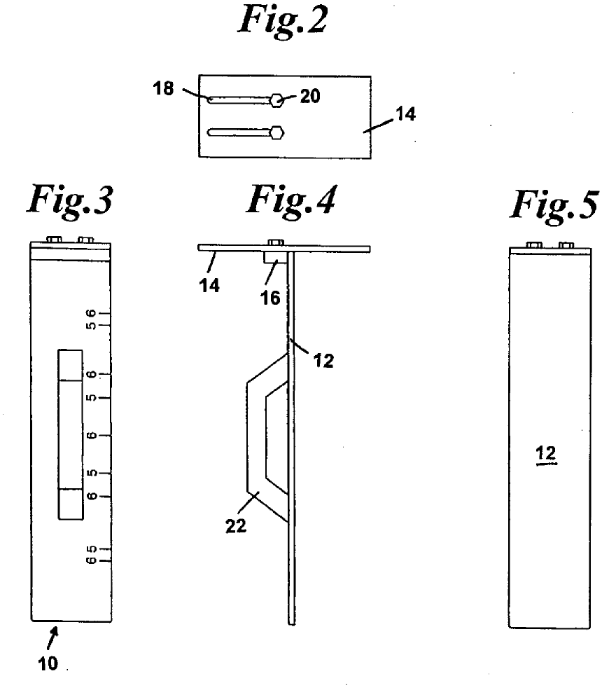

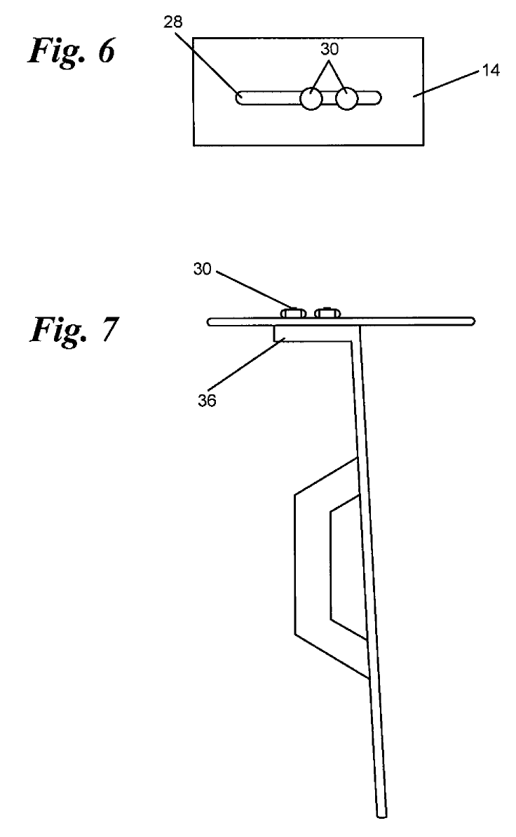

The adjusting mechanism can be a pair of parallel slots 18 in the cross member with an adjusting screw or bolt 20 in each as shown in FIGS. 2 and 4, or it can be a single slot 28 in the cross member with a pair of adjusting bolts 30 in the slot 28 as shown in FIGS. 6 and 7 to hold the cross member in proper orientation, which is normal (at a right angle) to the elongated member.

Embodiments of the invention may provide an improved method and apparatus for laying a brick wall, particularly in heretofore difficult to lay regions of a structure, and a toot for aiding in laying a brick wall a set distance from the base wall of a structure, and to confirm the verticality of the brick wall face faster and more economically than heretofore has been possible.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

That which is claimed:

1. A tool for vertically aligning bricks in a wall, comprising:
an elongated member for placing against an outer face of a brick wall; and
a cross member for placing against a top course of brick in the brick wall;
wherein the cross member is attached to the elongated member at a right angle thereto; and
wherein a position of a distal end of the cross member relative to the elongated member is adjustable.

2. The tool according to claim 1, wherein each member has a substantially planar surface for contacting bricks.

3. The tool according to claim 1, further comprising a handle attached to said elongated member.

4. The tool according to claim 1, wherein said cross member is provided with an elongated slot in its longitudinal direction, and wherein the position of the distal end of the cross member relative to the elongated member is adjustable via an adjusting screw extending through the slot in the cross member into the elongated member.

5. The tool according to claim 1, wherein the tool comprises aluminum, steel, wood, and plastics, or a combination thereof.

6. The tool according to claim 1, wherein the members are substantially rectangular and have substantially planar inner and outer faces.

7. The tool according to claim 1, wherein the elongated member is provided with a scale with measurements stamped or etched thereon at various desired locations.

8. A method for vertically aligning bricks in a wall, comprising:
providing a tool for vertically aligning bricks, the tool comprising:
an elongated member for placing against a face of a brick wall; and
a cross member for placing against a top course of brick in the brick wall, wherein the cross member is attached to the elongated member at a right angle thereto, and wherein a position of a distal end of the cross member relative to the elongated member is adjustable;
determining a distance from an outer surface of a base wall to the face of a brick wall to be laid;
fixing the position of the distal end of the cross member relative to the elongated member to correspond to the distance;
in the laying of the brick wall, determining the verticality of the brick wall by placing a bottom surface of the cross member on a top course of brick in the brick wall and an inner face of the elongated member on a face of the brick wall, wherein the distal end of the cross member contacts an outer surface of the base wall; and
adjusting the vertical alignment of the bricks as necessary to conform to the distance.
